(19) United States
(12) Patent Application Publication
(10) Pub. No.: US 2024/0041014 A1
(43) Pub. Date: Feb. 8, 2024

(54) FISHING REEL AND ATTACHMENT/DETACHMENT UNIT IN FISHING REEL

(71) Applicant: Shimano Inc., Osaka (JP)

(72) Inventors: Kunio TAKECHI, Osaka (JP); Hiroki OOGOSE, Osaka (JP)

(21) Appl. No.: 18/203,464

(22) Filed: May 30, 2023

(30) Foreign Application Priority Data
Aug. 3, 2022 (JP) 2022-124214

(51) Int. Cl. A01K 97/00; A01K 89/015

(52) U.S. Cl. CPC A01K 97/00; A01K 89/015

(57) ABSTRACT

A fishing reel includes a reel body and a power supply unit disposed in the reel body of a fishing reel, power supply unit receives electric power wirelessly transmitted from an external wireless power supply device, and configured to supply the received electric power.

### CROSS-REFERENCE TO RELATED APPLICATIONS

This application claims priority to Japanese Patent Application Nos. 2022-124214, filed on Aug. 3, 2022. The entire disclosure of Japanese Patent Application No. 2022-124214 are hereby incorporated by reference.

### BACKGROUND

### Technical Field

The present disclosure relates to a fishing reel and an attachment/detachment unit in a fishing reel; more specifically, present disclosure relates to a fishing reel and an attachment/detachment unit in a fishing reel that contains a plurality of electronic components arranged on a circuit board that includes electronic components and a microcomputer (CPU).

### Background Information

In conventional fishing reels that contain a plurality of electrical components arranged on a circuit board that includes electronic components and a microcomputer (CPU), an enclosed circuit board, together with the electronic components, can covered with an insulating film (for example, refer to Japanese Patent No. 4384876).

Further, some reels include an external device connection part for connecting to external devices in order to check whether the control program of the CPU, etc., is operating normally, or to modify the control program by upgrading the version or changing software settings, as necessary, or in order to provide a charging/power supply terminal for charging and supplying electric power from the outside.

### SUMMARY

It has been determined that in such conventional fishing reels, despite the fact that the enclosed circuit board and the electrical components are covered with an insulating film, as is the case in Japanese Patent No. 4384876, because external devices are connected by a cable to the connector part serving as an external device connection part, water or foreign matter can enter through the external device connection part and cause the device to fail.

Further, in a similar manner, the charging/power supply terminal for charging and supplying electric power can also cause device failure due to the entry of water or foreign matter through the charging/power supply terminal.

An object of the present disclosure is to provide a system that enables supplying of electric power without the need for a cable connection. Another object of the present disclosure is to enable the circuit board, which includes electronic components and a microcomputer (CPU) to receive the supplied electric power for performing operations in accordance with prescribed functions.

A first aspect of the present disclosure that solves the problem described above is a fishing reel comprising a power supply unit that is disposed in a reel body of a fishing reel, that receives electric power wirelessly transmitted from an external wireless power supply device, and that can supply the received electric power.

A second aspect of the present disclosure is the fishing reel according to the first aspect, wherein the power supply unit can comprise a power-receiving unit for receiving electric power wirelessly transmitted from the external wireless power supply device, and a power supply unit for supplying power to an electrical device disposed in the reel body.

A third aspect of the present disclosure is the fishing reel according to the first or second aspect, that can further comprise an operation unit that is disposed in the reel body, that receives electric power from the power supply unit, and that performs operations in accordance with prescribed functions.

I fourth aspect of the present disclosure is the fishing reel according to the third aspect, wherein the operation unit can operate when the power supply unit is receiving electric power wirelessly transmitted from the external wireless power supply device.

A fifth aspect of the present disclosure is the fishing reel according to the third or fourth aspect, wherein the operation unit can have a communication unit that communicates with an external communication device.

A sixth aspect of the present disclosure is the fishing reel according to the fifth aspect, wherein the communication unit can communicate wirelessly with the external communication device.

A seventh aspect of the present disclosure is the fishing reel according to the fifth or sixth aspect, wherein the operation unit can have a parameter setting unit that acquires parameter setting information indicating the content of parameter settings transmitted from an external communication device connected to the communication unit so as to be capable of communication, and that sets prescribed parameters for the fishing reel based on the acquired parameter setting information.

An eighth aspect of the present disclosure is the fishing reel according to any one of the fifth through the seventh aspects, wherein the operation unit can have a data transmission control unit that causes data stored in a storage unit to be transmitted to the external communication device communicatively connected to the communication unit.

A ninth aspect of the present disclosure is the fishing reel according to any one of the fifth through the eighth aspects, wherein the reel body has a detachable unit that can be attached and detached, and the detachable unit includes the power supply unit, the operation unit, and a communication unit in a watertight structure.

a tenth aspect of the present disclosure is the fishing reel according to the ninth aspect, wherein the reel body can include a first body part that holds one end of a spool shaft so as to be rotatable and to which a handle shaft is attached, and a second body part that holds the other end of the spool shaft so as to be rotatable, and wherein the detachable unit can be disposed in the second body part.

An eleventh aspect of the present disclosure is a detachable unit of a fishing reel that can be attached to/detached from the reel body of a fishing reel, comprising a watertight housing that includes a power supply unit that can receive electric power wirelessly transmitted from an external wireless power supply device, an operation unit that receives electric power from the power supply unit and performs operations in accordance with prescribed functions, and a communication unit that communicates with an external communication device.

By the present disclosure, electric power can be supplied to a fishing reel without a cable connection. Also, the fishing reel can perform operations in accordance with prescribed functions by receiving the supply of power.

### BRIEF DESCRIPTION OF THE DRAWINGS

FIG. 1 shows an example of the external appearance of the fishing reel according to the present embodiment.

FIG. 2 shows an example of the external appearance of the fishing reel according to the present embodiment with the detachable unit removed from the body part.

FIG. 3 shows an example of the arrangement of the circuit unit in the detachable unit according to the present embodiment.

FIG. 4 shows the detachable unit, wireless power supply device, and a user terminal 300 according to the present embodiment.

FIG. 5 is a diagram showing an example of the functional configuration of the detachable unit according to the present embodiment.

FIG. 6 is a flowchart showing an example of a processing procedure that is performed by the circuit unit and the user terminal according to the present embodiment in connection with the setting of braking control parameters and the transfer of a casting log.

### DETAILED DESCRIPTION OF EMBODIMENTS

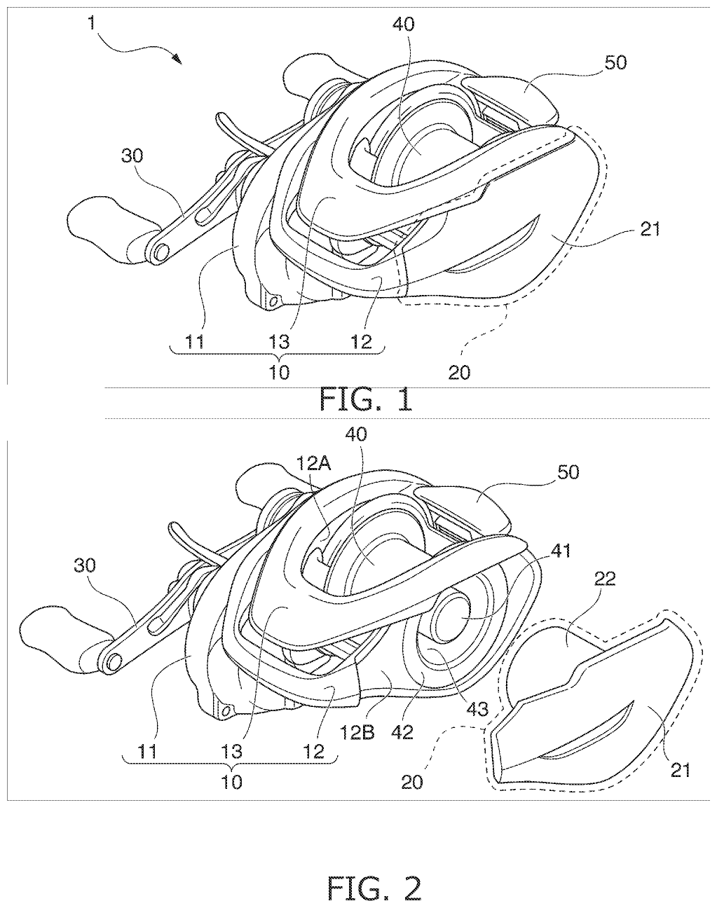

FIGS. 1 and 2 illustrate examples of the external appearance of a fishing reel 1 according to the present embodiment. FIG. 1 shows an example of the external appearance of the fishing reel 1 with a detachable unit 20 attached to a main body 10. FIG. 2 shows an example of the external appearance of the fishing reel 1 with the detachable unit 20 removed from the main body 10 (one example of the reel body).

FIGS. 1 and 2 illustrate an example of the fishing reel 1, which is a dual-bearing reel.

The fishing reel 1 of the same figures comprises the main body 10, a handle 30, a spool 40, and a clutch operating unit 50.

The main body 10 includes the main body 10 and the detachable unit 20. The main body 10 includes side plate part 11, a frame part 12, and a thumb rest 13.

The frame part 12 includes a handle-side frame part 12A (one example of a first body part) that holds one end of a spool shaft of the spool 40 so as to be rotatable and to which a handle shaft is attached, and a hold-side frame part 12B (one example of a second body part) that holds the spool 40 so as to be rotatable at the other end of the spool shaft of the spool 40.

The detachable unit 20 can be attached to/detached from the main body 10. Specifically, the detachable unit 20 is disposed on the hold-side frame part 12B, which is on the side of the main body 10 opposite the handle 30.

When the detachable unit 20 is mounted on the main body 10 as shown in FIG. 1, the main body 10 and a cover 21 of the detachable unit 20 form the contours of the fishing reel 1.

As shown in FIG. 2, the detachable unit 20 includes a braking unit part 22 that is integral with the rear side of the cover 21. The braking unit part 22 is a part that houses a braking member that brakes the spool 40 that rotates freely during casting. The braking unit part 22 is provided so as to be integral with the detachable unit 20 including the cover 21.

When the detachable unit 20 is mounted on the main body 10, the braking unit part 22 is inserted into a circular spool space 43 between a spool shaft 41 and a spool periphery 42 on the side surface of the spool 40.

That is, the main body 10 holds one end of the spool shaft 41 so as to be rotatable, and the detachable unit 20 holds the other end of the spool shaft 41 so as to be rotatable.

A braking magnet is disposed on the spool shaft 41. The spool shaft 41 rotates together with the spool 40. With the detachable unit 20 mounted on the main body 10 and the braking unit part 22 inserted into the spool space 43, a brake unit inside the braking unit part 22 is in a state in which a plurality of coils are arranged to surround the outer circumference of the spool shaft 41. The plurality of coils are connected in series.

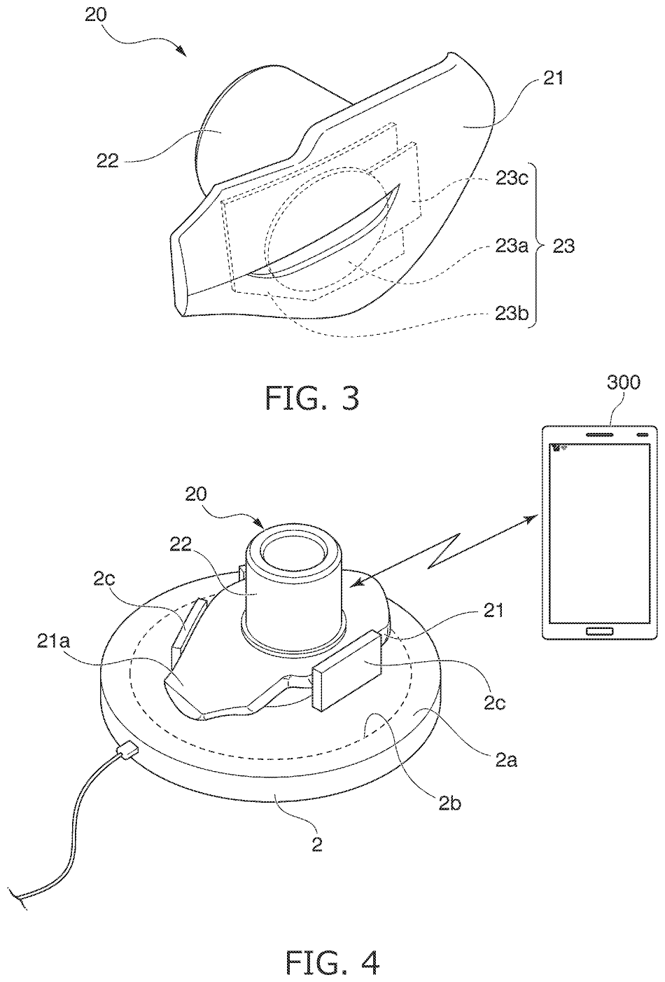

FIG. 3 shows an example of an arrangement mode of a circuit unit part 23 (one example of an electrical device) housed inside a housing of the detachable unit 20.

The circuit unit part 23 includes a power-receiving coil 23a (one example of a power-receiving unit), a circuit board 23b, and a communication module 23c (one example of a communication unit). The circuit unit part 23 can be formed as a single component by fixing the power-receiving coil 23a, the circuit board 23b, and the communication module 23c to each other.

The power-receiving coil 23a receives electric power transmitted from a power-transmitting coil of a wireless power supply device 2. The electric power received by the power-receiving coil 23a is converted into direct current and supplied to the communication module 23c or a designated circuit section of the circuit board 23b.

The communication module 23c is a module capable of communicating with an external communication device by a prescribed short-range wireless communication method. The short-range wireless communication method that the communication module 23c supports is not particularly limited and can be BLE (Bluetooth Low Energy), NFC (Near Field Communication), etc.

The circuit board 23b is a board on which a circuit (brake circuit) corresponding to braking control by the braking unit is mounted. A CPU (Central Processing Unit), a memory unit, and the like, which constitute the brake circuit, are mounted on the circuit board 23b. Also mounted on the circuit board 23b can be circuit components corresponding to a power supply unit that can convert AC power received by the power-receiving coil 23a into DC power and output the DC power.

The circuit (brake circuit) related to braking control mounted on the circuit board 23b can be operated by the electric power generated in the coil of the brake unit inside the braking unit part 22 in accordance with the rotation of the spool 40. When braking control is performed during casting, the circuit corresponding to the braking control on the circuit board 23b is operated by the electric power generated in the coil of the brake unit.

The brake circuit mounted on the circuit board 23b can also be operated by the electric power from the power-receiving coil 23a. When the parameters related to the braking control are changed or a casting log stored in memory are transmitted to a user terminal via communication with the user terminal, the circuit corresponding to the braking control on the circuit board 23b is operated by the electric power supplied from the power-receiving coil 23a.

In the present embodiment, the communication module 23c is operated by a power source based on electric power supplied from the power-receiving coil 23a, as described above. The communication module 23c can be configured to operate from the electric power generated in accordance with the rotation of the spool 40 due to casting.

In the present embodiment, the housing of the detachable unit 20 is formed to be watertight. Because the circuit unit part 23 is housed (included) in the watertight housing of the detachable unit 20, the circuit unit part 23 will not be inundated with water.

The braking control of the brake unit of the fishing reel 1 according to the present embodiment will be described.

An angler releases the clutch so that the spool 40 can rotate freely before casting a lure. In response to the cast, the spool 40 rotates in the direction in which the wound fishing line is paid out.

As the spool 40 rotates, the coil in the brake unit generates electricity, and the generated electricity is supplied to the circuit board 23b. The brake circuit in the circuit board 23b is activated by the power supplied in this manner.

The braking mode and braking intensity set by the angler are stored in memory. As a braking control, the brake circuit sets the duty ratio of a PWM signal with a prescribed cycle for the brake switch disposed in the path of the electrical current flowing through the coil of the brake unit based on the combination of the set braking mode and braking intensity, thereby performing on/off control.

The braking mode is a parameter that indicates a defined pattern of changes in the duty ratio of the PWM signal over time. In each braking mode, the duty ratio decreases with time, but the maximum and minimum values of the range of change of the duty ratio and the pattern of the duty ratio that decrease with time differ for each braking mode.

The braking intensity is a parameter for adjusting the intensity of braking under the set braking mode.

The number of braking modes and the number of braking intensities in the setting that can be selected are not particularly limited. For example, if the number of braking modes that can be selected is four and the number of braking intensities that can be selected is eight, 32 (4×8) combinations of braking modes and braking intensities are obtained. For each of the 32 combinations of the braking mode and braking intensity, the pattern in which the duty ratio for braking the rotation of the spool 40 changes with time.

The brake circuit changes the duty ratio of the PWM signal with time in accordance with the duty ratio per time determined by the set combination of the braking mode and braking intensity.

In this way, the brake circuit changes the duty ratio of the PWM signal to control the on/off time of the brake switch, thereby maintaining suitable tension on the fishing line that is paid out from the spool 40 and preventing backlash.

As described above, the fishing reel 1 of the present embodiment has the braking mode and the braking intensity as braking control parameters corresponding to braking control for preventing backlash during casting. The angler can set the braking control parameters with a user terminal that the angler holds. The procedure for setting the braking control parameters carried out by the angler using a user terminal will be described below with reference to FIG. 4. FIG. 4 shows the detachable unit 20 placed on the wireless power supply device 2 and the user terminal 300 that communicates with the detachable unit 20.

For example, when changing the setting of a braking control parameter, the angler removes the detachable unit 20 from the main body 10 of the fishing reel 1 and places the unit on a power supply surface part 2a of the wireless power supply device 2. When the detachable unit 20 is placed on the wireless power supply device 2, power is transmitted from a power-supplying coil 2b inside the wireless power supply device 2 to the power-receiving coil 23a of the detachable unit 20.

In order to ensure good power transmission, the power feeding coil of the wireless power supply device 2 and the power-receiving coil 23a of the detachable unit 20 are preferably positioned opposite each other. Specifically, when the power-receiving coil 23a is disposed inside the detachable unit 20, as shown in FIG. 3, it is preferable to place the detachable unit 20 on the power supply surface part 2a such that the surface that is the side surface in a state in which the cover 21 of the detachable unit 20 is attached to the main body 10 is oriented downward, as shown in FIG. 4.

FIG. 4 shows an example in which positioning members 2c, 2c corresponding to the shape of the detachable unit 20 are disposed on the power supply surface part 2a of the wireless power supply device 2 so as to maintain the orientation of the detachable unit 20.

Further, the detachable unit 20 internally houses the circuit unit part 23 by a watertight structure. Therefore, a rear surface cover part 21a of the cover 21 of the detachable unit 20 covers the rear surface side such that the interior is not exposed.

The power-receiving coil 23a within the detachable unit 20 supplies the power transmitted from the wireless power supply device 2 to the circuit board 23b and the communication module 23c, for example.

In the circuit unit part 23 housed in the detachable unit 20, the communication module 23c is not operated by a source of power derived from the power generated by the rotation of the spool 40 (spool rotation-derived power source: hereinafter, referred to simply as “spool power source”), but is operated by a source of power based on the power transmitted from a wireless power supply device via the power-receiving coil 23a (power source derived from a power supply device: hereinafter, simply referred to as “power supply power source”). Therefore, the communication module 23c is configured such that, in a state in which the detachable unit 20 is placed on the wireless power supply device 2 and is receiving power, as shown in FIG. 4, the communication module 23c can operate continuously.

In the present embodiment, the communication module 23c is configured not to be operated by the spool power source, but by the surplus of the spool power source, or to be operated by storing the surplus of the spool power source.

In FIG. 4, an example is shown in which the detachable unit 20 that has been removed from the main body 10 of the fishing reel 1 is placed on the wireless power supply device 2, but the detachable unit 20 side of the fishing reel 1 can abut against the power supply surface part 2a of the wireless power supply device 2 without being removed from the main body 10. In addition, when the detachable unit 20 abuts against the wireless power supply device 2 without being removed from the main body 10, the fishing reel 1 itself can still be attached to the fishing rod.

A management application with a function for setting the braking control parameters is installed in the user terminal 300 (one example of an external communication device).

The angler operates the user terminal 300 by operating the management application with the detachable unit 20 placed on the wireless power supply device 2 and the communication module 23c in operation, as shown in FIG. 4.

The user terminal 300 on which the management application runs carries out short-range wireless communication with the communication module 23c of the detachable unit 20. The user terminal 300 stores the braking control parameters (braking mode, braking intensity) specified by the angler's operation in the memory mounted on the circuit board 23b in the detachable unit 20 while in a state of connection to the communication module 23c via short-range wireless communication. In this manner, the angler can set the braking control parameters by operating the user terminal 300.

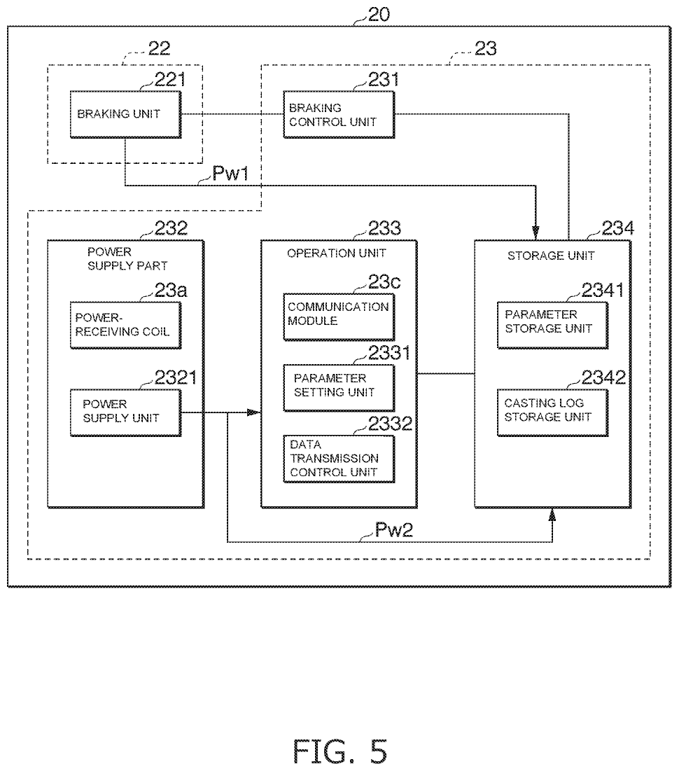

An example of a functional configuration of the detachable unit 20 according to the present embodiment will be described with reference to FIG. 5. The functional configuration example shown in FIG. 5 is realized by the circuit unit part 23 and the brake unit housed in the detachable unit 20.

The detachable unit 20 shown in FIG. 5 includes a braking unit (brake) 221. The braking unit 221 is housed in the braking unit part 22 and brakes the spool 40 during casting, in accordance with control (PWM control) of a braking control unit 231.

The braking unit 221 can supply the electric power generated by the internal coil in accordance with the rotation of the spool 40 during casting as a power source (spool power source Pw1) for operating circuits, etc., respectively corresponding to the braking control unit 231 and a storage unit 234.

In addition, the detachable unit 20 includes the braking control unit 231, a power supply part 232, an operation unit 233, and the storage unit 234, as functional units realized by components mounted in the circuit unit part 23.

The braking control unit 231 performs braking control. The circuit corresponding to the braking control unit 231 in the circuit unit part 23 can be operated by receiving power supplied from the spool power source Pw1. The function as the braking control unit 231 is realized, for example, by the execution of a program by a CPU installed in the circuit unit part 23.

When activated by receiving power supplied from the spool power source Pw1, the braking control unit 231 reads the braking control parameters (braking mode, braking intensity) stored as set values in a parameter storage unit 2341 that is activated by receiving the same cast-compatible supply of power. The braking control unit 231 sets the duty ratio for each time in accordance with the read out braking control parameters and controls the on/off time of the brake switch in the braking unit 221 according to the set duty ratio, thereby braking the rotation of the spool 40.

The power supply part 232 outputs the power (power supply power source Pw2) generated from the electric power transmitted from the wireless power supply device 2 to the power-receiving coil 23a. The power supply part 232 includes the power-receiving coil 23a and a power supply unit 2321 (one example of a power supply unit).

Electric power transmitted from the wireless power supply device 2 to the power-receiving coil 23a is input to the power supply unit 2321. The power supply unit 2321 converts the input electric power into DC, thereby generating the power supply power source Pw2. The power supply unit 2321 supplies the generated power supply power source Pw2 to a circuit corresponding to the storage unit 234 and the operation unit 233 in the circuit unit part 23.

The operation unit 233 operates by receiving power from the power supply power source Pw2 from the power supply part 232 and executes a process corresponding to the functions (application-compatible functions) realized with communication with the user terminal 300 on which the management application is running. The application-compatible functions in the present embodiment are the setting of the braking control parameters and the transfer of the casting log.

The setting of the braking control parameters is a function used for braking control in accordance with the control of the communication-capable connected user terminal 300. The transfer of the casting log is a function for transferring the casting log operation unit 233 data stored in a casting log storage unit 2342 to the communication-capable connected user terminal 300.

The operation unit 233 includes the communication module 23c, a parameter setting unit 2331, and a data transmission control unit 2332.

The parameter setting unit 2331 sets the braking control parameters used for braking control as specified by the user terminal 300 connected via communication performed by the communication module 23c. The parameter setting unit 2331 causes the braking control parameters specified by the user terminal 300 to be stored in the parameter storage unit 2341, thereby setting the braking control parameters used for braking control.

In response to a request from the user terminal 300 connected via communication carried out by the communication module 23c, the data transmission control unit 2332 causes the casting log data stored in the casting log storage unit 2342 to be transmitted to the user terminal 300 via the communication module 23c.

The storage unit 234 stores prescribed information. The hardware supported by the storage unit 234 can be a storage device such as flash memory mounted on the circuit board 23b, for example. The storage unit 234 can be operated by the spool power source Pw1 from the braking unit 221 at the time of casting and can be operated by the power supply power source Pw2 when the power-receiving coil 23a receives power supplied from the wireless power supply device 2.

The storage unit 234 includes the parameter storage unit 2341 and the casting log storage unit 2342. The parameter storage unit 2341 stores the braking control parameters (braking mode, braking intensity) set to be used by the braking control unit 231 for braking control.

The casting log storage unit 2342 stores casting log data. A casting log is a history of casts made by an angler. A casting log corresponding to one cast can include the date and time of the cast, the flight distance, the change in tension during the cast, the braking control pattern that was set during the cast, etc.

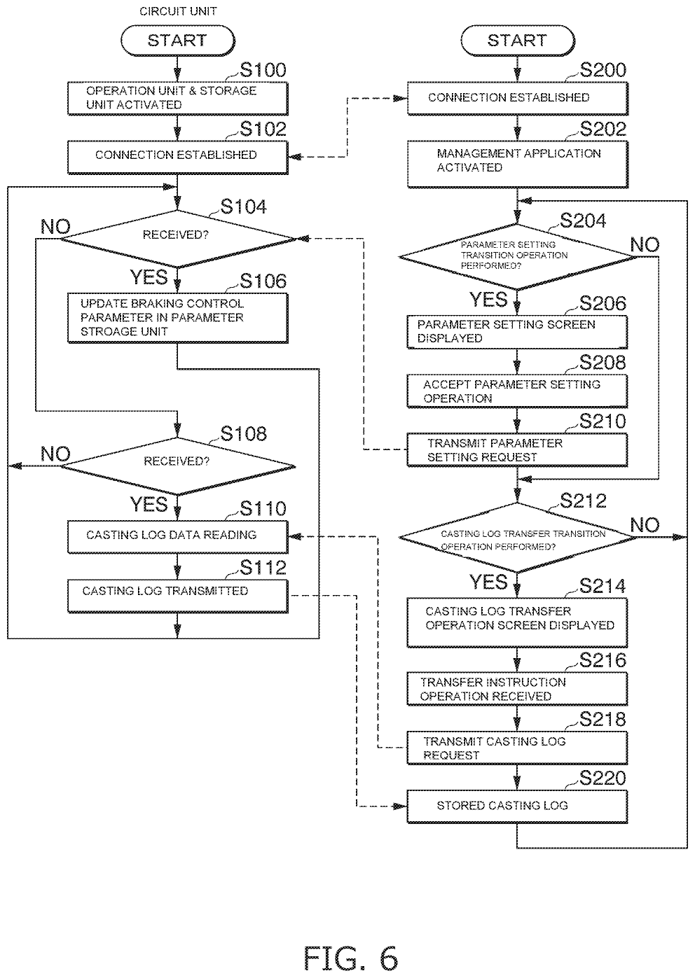

An example of a processing procedure to be executed by the user terminal 300 and the circuit unit part 23 in the detachable unit 20 in connection with a transfer of the casting log and the setting of the braking control parameters will be described with reference to the flowchart of FIG. 6.

First, an example of a processing procedure executed by the circuit unit part 23 will be described.

Step S100: In accordance with the circuit unit part 23, the power supply unit 2321 outputs the power supply power source Pw2 in response to power being transmitted from the wireless power supply device 2 to the power-receiving coil 23a. The operation unit 233 and the storage unit 234 are activated in response to the power supplied by the power supply power source Pw2.

Step S102: After activation, the communication module 23c establishes a connection with the user terminal 300 in response to the user terminal 300 being located within the communication range of the communication module 23c.

Step S104: With the connection established, the parameter setting unit 2331 of the circuit unit part 23 determines whether the communication module 23c has received a parameter setting request transmitted from the user terminal 300.

Step S106: When the communication module 23c receives a parameter setting request, the parameter setting unit 2331 updates the braking control parameters stored in the parameter storage unit 2341 with the braking control parameters indicated by the parameter setting information included in the received parameter setting request. By updating the braking control parameters in this manner, a setting is made such that the braking control parameters are changed.

Step S108: If it is determined that a parameter setting request has not been received in Step S104, the data transmission control unit 2332 determines whether a casting log transfer request has been received. If it is determined that a casting log transfer request has not been received, the process returns to Step S104.

Step S110: If it is determined that a casting log transfer request has been received in Step S108, the data transmission control unit 2332 reads the casting log data from the casting log storage unit 2342. At this time, in the case that the casting log transfer request specifies the conditions of the casting log to be read, the data transmission control unit 2332 can read from the casting log storage unit 2342 the casting log that matches the conditions.

Step S112: The data transmission control unit 2332 causes the casting log read from the casting log storage unit 2342 in Step S110 to be transmitted from the communication module 23c to the user terminal 300. After the processing of Step S112, the process returns to Step S104.

An example of a process procedure executed by the user terminal 300 will now be described.

Step S200: The user terminal 300 establishes communication with the circuit unit part 23 located within the communication range of its own communication module.

Step S202: The user terminal 300 activates a management application in accordance with the angler's operation. The establishment of connection as Step S200 can be carried out after activation of the management application.

Step S204: The user terminal 300 determines whether an operation (parameter setting transition operation) to transition to the setting of the braking control parameters has been performed in a state in which the management application is running.

Step S206: If it is determined in Step S204 that a parameter setting transition operation has been performed, the user terminal 300 displays a parameter setting screen as an application screen in the display unit of the user terminal 300. The parameter setting screen is a screen in which an operation (parameter setting operation) for setting the braking control parameters is performed.

Step S208: The user terminal 300 accepts a parameter setting operation for the parameter setting screen displayed in Step S206.

The parameter setting operation can be an operation to select at least one of the braking modes and braking intensities of the braking control parameters from a prescribed number of options prepared in advance. Specifically, as described above, if the number of braking modes that can be selected is four and the number of braking intensities that can be selected is eight, the parameter setting operation includes an operation to select one of the four braking mode options, and an operation to select one of the eight braking intensity options.

Step S210: The user terminal 300 transmits a parameter setting request to the communication module 23c of the circuit unit part 23 for issuing an instruction to set (change) the braking control parameters. The parameter setting request includes parameter setting information indicating the braking control parameters selected by the parameter setting operation in Step S208.

Step S212: If it is determined in Step S204 that a parameter setting transition operation has not been carried out, the user terminal 300 determines whether a casting log transfer transition operation has been carried out. A casting log transfer transition operation is an operation for displaying a casting log transfer screen in which it is possible to carry out an operation to transfer a casting log to the circuit unit part 23.

Step S214, if a casting log transfer transition operation has been carried out, the user terminal 300 displays a casting log transfer operation screen on the display unit.

Step S216: The user terminal 300 receives an operation (transfer instruction operation) related to the transfer instruction of the casting log to the user terminal 300, which is performed by the user with respect to the casting log transfer operation screen displayed in Step S214. In the transfer instruction operation, for example, conditions of the casting log to be transferred can be specified. Examples of conditions of the casting log to be transferred include the date and time of the cast to be transferred, the braking control parameters that had been set, etc.

Step S218: The user terminal 300 transmits a casting log transfer request to the communication module 23c of the circuit unit part 23, in accordance with the transfer instruction operation received in Step S216. The casting log to be transmitted can include the contents specified by the transfer instruction operation regarding the casting log conditions.

Step S220: In response to transmission of the casting log transfer request in Step S218, in Step S112, the circuit unit part 23 transmits the casting log. The user terminal 300 receives the transmitted casting log and stores the received casting log in the storage unit disposed in the user terminal 300.

In this embodiment of the fish reel 1, the operating unit 233 (communication module 23c, parameter setting unit 2331, and data transmission control unit 2332) in the circuit unit part 23 operates when the detachable unit 20 is receiving a wireless supply of power from the wireless power supply device 2 as described above. Thus, in the present embodiment, as long as the circuit unit part 23 is in a state of receiving a wireless supply of power from the wireless power supply device 2, the user terminal 300 can be communicatively connected to the communication module 23c, thereby performing the setting of the braking control parameters, the transfer of the casting log, etc.

In this embodiment, a battery to supply power to the circuit unit part 23 is not necessary to set the braking control parameters, transfer the casting log, etc. That is, there is no need to incorporate a battery inside the detachable unit 20. This embodiment makes it possible to avoid an increase in the size and weight of the detachable unit 20. This embodiment thus avoids an increase in the size and weight of the fishing reel 1 on which the detachable unit 20 is mounted.

Further, employing a wireless power supply eliminates the need to equip the detachable unit 20 with a terminal, etc., to draw power from the outside. It is thus possible to easily make the detachable unit 20 watertight. In addition, by enabling communication between the user terminal 300 and the communication module 23c in the detachable unit 20 only when wireless power is being supplied so that the braking control parameters can be set, the casting log transferred, etc., there is also no need to incorporate a battery in the detachable unit 20. This embodiment also eliminates the need to configure the housing of the detachable unit 20 so that a battery can be replaced in response to battery failure or deterioration, for example. This also contributes to ensuring the watertightness of the detachable unit 20.

In the present embodiment, the detachable unit 20 can have a structure that is not watertight.

In the embodiment described above, an example was described in which the circuit unit part 23 is disposed in the detachable unit 20, which can be attached to/detached from the main body 10 of the fishing reel 1. However, the circuit unit part 23 can be configured to be housed in the main body of a fishing reel that does not have a detachable body part like the detachable unit 20 of the present embodiment.

A program for realizing the above-described functions of the circuit unit part 23 and the user terminal 300 can be recorded or stored on a computer-readable storage medium, and by having a computer system read and execute the program that is stored on this storage medium, the processes of the above-described circuit unit part 23, the user terminal 300, and the like, can be executed. Here, “having a computer system read and execute the program that is stored on this storage medium” includes the installation of the program in the computer system. The “computer system” here includes the OS and hardware such as peripheral devices. In addition, the “computer system” can also include a plurality of computer devices that are connected via a network, including the Internet and communication lines such as WAN, LAN, and dedicated lines. Further, the “computer-readable storage medium” refers to storage devices such as portable media such as flexible discs, magneto-optical discs, ROM, and CD-ROM, and HDD, SSD, and the like, that are incorporated in a computer system. In this manner, the storage medium that stores the program can be a non-transitory storage medium, such as a CD-ROM. Further, the storage medium includes an internally or externally provided storage medium that can be accessed from a distribution server in order to distribute the aforementioned program. The code of the program that is stored on the storage medium of the distribution server can be different from the code of the program that is in a format that can be executed by the terminal device. That is, as long as the program can be downloaded from the distribution server and installed in a form that can be executed by the terminal device, the format in which the program is stored in the distribution server is not limited. The program can be divided into a plurality of modules and merged on the terminal device after downloading at different timings, or the distribution server that distributes each of the divided programs can be different. Moreover, the “computer-readable storage medium” shall also include media that retains the program for a set period of time, such as volatile memory (RAM) in the computer system which acts as the server or the client when the program is transmitted via the network. In addition, the above-described program can realize some of the above-described functions. Moreover, it can be a program that can realize the above-described functions by being combined with a program that is already stored in the computer system, i.e., a so-called difference file (difference program).

What is claimed is:

1. A fishing reel, comprising:
a reel body; and
a power supply unit disposed in the reel body, the power supply unit configured to receive electric power wirelessly transmitted from an external wireless power supply device, and configured to supply the received electric power.

2. The fishing reel according to claim 1, wherein
the power supply unit comprises
a power-receiving unit configured to receive the electric power wirelessly transmitted from the external wireless power supply device, and
a power supply unit configured to supply power to an electrical device disposed in the reel body.

3. The fishing reel according to claim 1, further comprising
an operation unit disposed in the reel body, the operation unit configured to receive the electric power supplied by the power supply unit, and configured to perform operations corresponding to prescribed functions.

4. The fishing reel according to claim 3, wherein
the operation unit is configured to operate when the power supply unit is receiving the electric power wirelessly transmitted from the external wireless power supply device.

5. The fishing reel according to claim 4, wherein
the operation unit has a communication unit configured to communicate with an external communication device.

6. The fishing reel according to claim 5, wherein
the communication unit is configured to communicate wirelessly with the external communication device.

7. The fishing reel according to claim 5, wherein
the operation unit includes
a parameter setting unit configured to acquire parameter setting information indicating contents of parameter settings transmitted from an external communication device communicatively connected to the communication unit and set prescribed parameters for the fishing reel based on the acquired parameter setting information.

8. The fishing reel according to claim 5, wherein
the operation unit has
a data transmission control unit configured to cause the external communication device connected to the communication unit by communication to transmit data stored in a storage unit.

9. The fishing reel according to claim 5, wherein
the reel body has a detachable unit configured to be attached and detached, the detachable unit including a power supply unit, the operation unit, and a communication unit in a watertight structure.

10. The fishing reel according to claim 9, wherein
the reel body includes a first body part configured to hold a first end of a spool shaft so as to be rotatable and to which a handle shaft is attached, and a second body part configured to hold a second end of the spool shaft so as to be rotatable, and the detachable unit is disposed in the second body part.

11. A detachable unit of a fishing reel configured to be attached to/detached from a reel body of a fishing reel, comprising:
a watertight housing including a power supply unit configured to receive electric power wirelessly transmitted from an external wireless power supply device, an operation unit configured to receive the electric power supplied from the power supply unit and perform operations corresponding to prescribed functions, and a communication unit configured to communicate with an external communication device.
